(19) United States
(12) Patent Application Publication
(10) Pub. No.: US 2022/0234104 A1
(43) Pub. Date: Jul. 28, 2022

(54) ADDITIVE MANUFACTURING USING FUGITIVE FLUIDS

(71) Applicant: Desktop Metal, Inc., Burlington, MA (US)

(72) Inventors: Michael A. Gibson, Philadephia, PA (US); Richard Remo Fontana, Cape Elizabeth, MA (US); George Hudelson, Billerica, MA (US); Christopher Benjamin Renner, Cambridge, MA (US); Paul A. Hoisington, Hanover, NH (US); Anna Marie Trump, Burlington, MA (US)

(73) Assignee: Desktop Metal, Inc., Burlington, MA (US)

(21) Appl. No.: 17/521,477

(22) Filed: Nov. 8, 2021

Related U.S. Application Data
(60) Provisional application No. 63/111,039, filed on Nov. 8, 2020.

(51) Int. Cl. B22F 10/14; B33Y 10/00; B33Y 30/00; B22F 10/64; B22F 10/68; B33Y 40/20

(52) U.S. Cl. CPC B22F 10/14; B33Y 10/00; B33Y 40/20; B22F 10/64; B22F 10/68; B33Y 30/00

(57) ABSTRACT

A method of metal additive manufacturing, including forming a three-dimensional object as a successive series of layers. At least some of the successive layers is formed by depositing a layer of build material powder on a work surface, depositing a predetermined pattern of fugitive fluid and depositing a predetermined pattern of binder fluid, wherein the predetermined pattern of fugitive fluid improves at least one characteristic of the three-dimensional part.

### TECHNICAL FIELD

The present disclosure relates to reducing smearing and bleeding in powder beds to improve printing consistency in binder jetting additive manufacturing.

### BACKGROUND OF THE DISCLOSURE

Binder jetting is an additive manufacturing technique by which a thin layer of powder is spread onto a working surface, followed by deposition of a liquid binder in a nominally 2D pattern or image that represents a single “slice” of a 3D shape. After deposition of binder, another layer of powder is spread, and the process is repeated to form a 3D volume of bound material within the powder bed. After printing, the bound part is removed from the excess powder, and sintered at high temperature to bind the particles together.

In general, it is difficult to have a consistent printing process without a consistent substrate. The powder in binder jet printing can be affected by whether or not the powder below a new layer it has been printed upon. For example, binder may bleed or smear into undesired areas or shifting may occur between layers where binder is not present. Anomalies may further propagate through subsequent layers.

In certain instances, additional structures may be printed not as parts themselves, but as printing aids that ameliorate problems with unbound powder. For example, binder may be printed in complementary volumes such as “smearing rafts” below parts or as lattices around parts. These complementary volumes are known to improve important aspects of the quality of the parts, such as surface finish and uniformity of density within parts.

While such additional structures may improve the final printed part they also need to be discarded after the printing process as they are bound powder that is not generally reusable. As a result, more powder will be consumed, and the ability to recycle powder will be limited. Additionally, in powder bed binder jetting there is the need to de-powder parts. If binder is printed between and around parts and the additional structures, de-powdering parts may be difficult due to interlocking of part and inter-part bound powder or adhesion at bordering surfaces between parts and inter-part bound powder.

### SUMMARY

As described below, a “fugitive” fluid may be employed to act similarly to binder during the printing process in terms of its effects on the powder bed, but that is easily removable from the powder bed during or after printing such that unbound powder may be more easily recycled.

The use of a fugitive fluid instead of an actual binder can reduce the amount of powder lost in the printing process by allowing the powder to be more easily de-powdered and recycled. In some cases, a 5-10% or more total reduction in powder consumption can be achieved over use of binder. In certain embodiments as a fugitive fluid may be used to make rafts under parts to be manufactured that improve part quality.

The fugitive or vanishing fluid may be removed entirely either during part manufacture or further processing or may leave a minimal residue that may be removed during further processing. The fugitive fluid is chemically distinct from the fluid used to make the parts (e.g., binder fluid), such that it does not bind the powder together in the same manner that the binder for the parts binds the powder together.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 is a top view of a powder bed having a layer of binder jetted in a predetermined pattern.

FIG. 2 is a side plan cutaway view of an embodiment system jetting fugitive fluid.

FIG. 3 is a flow chart of an embodiment process of jetting fugitive fluid.

FIG. 4 is a flow chart of an embodiment process of removing fugitive fluid.

FIG. 5 is a schematic side view of a powder bed in which a fugitive fluid forms a structure aiding the formation of a part with a separation distance of unbound powder.

FIG. 6 is a schematic side view of a powder bed in which a fugitive fluid forms a structure aiding the formation of an adjacent part.

FIG. 7 is a schematic side view of a powder bed in which a fugitive fluid forms a complementary structure surrounding at least a portion of the outer geometry of a part.

FIG. 8 is a schematic side view of a powder bed in which a fugitive fluid is applied to all the powder in a powder bed that is not bound into a part.

FIG. 9 is a schematic side view of a powder bed in which a fugitive fluid is applied to all the powder in a powder bed including that which is bound into a part.

### DETAILED DESCRIPTION

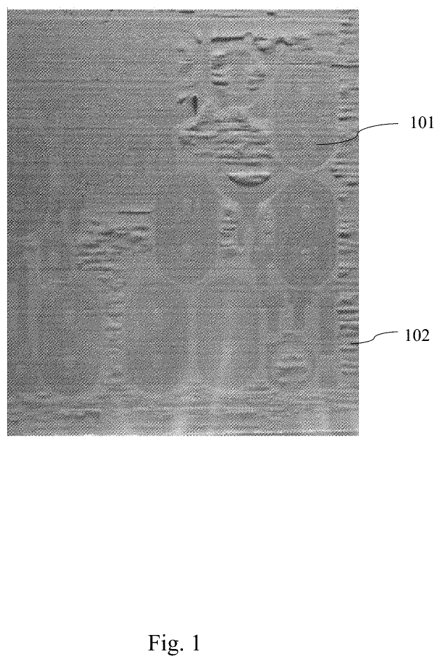

FIG. 1 depicts differences in powder topography between regions where binder jetting has occurred and loose powder. The lattice 101 where binder was jetted is relatively smooth, while the un-printed areas 102 are relatively wavy. Such differences in topography can negatively affect successive layers of powder during the jetting process.

Described below now is a method of printing a part with a binder fluid along with the printing of complementary volumes with a fugitive fluid where the powder from the complementary volumes can be easily recovered and reused. The fugitive fluid may either entirely disappear during productions steps or may be easily removed during further processing.

Generally, the fugitive fluid and application thereof will fulfill the following functional criteria.

With respect to powder mechanical properties and part surface finish, the fugitive fluid modifies the mechanical properties of complementary volumes where it is deposited by stiffening, densifying and/or immobilizing areas where it is deposited in a similar or the same manner as the binder jetted. This modification may improve the uniformity of the powder in the bed (both within and nearby the complementary volumes) and when combined with selection of appropriate regions of the bed may improve the quality of parts.

In general, addition of a fluid may have a dramatic effect on the properties of a granular material as can be appreciated by examination of wet and dry sand. These changes may be relatively insensitive to the nature of the fluid that is put into the granular material, provided the fluid has a contact angle with the granular material of less than 90° and preferably less than ˜60°. The variables affecting the mechanical properties of wet granular materials may include the surface tension of the fluid, the viscosity of the fluid, or the contact angle of the fluid. Given that the ink-jetting process may provide fairly tight constraints on surface tension and viscosity, most fluids that can be ink-jetted will have similar effects on the mechanical and packing properties of the powder bed. Fugitive fluids for use in described embodiments will further at a minimum be substantially non-binding and separable from the binder jetted part by a process that does not negatively affect the quality of the binder jetted part.

With respect to recyclability and removal, the fugitive fluid may be able to be removed via a method (e.g. evaporation) that allows for facile recycling and reuse of the powder that previously contacted the fugitive fluid. Removal methods of the fugitive fluid include: 1. concurrent evaporation with binder during drying and curing steps; 2. subsequent evaporation after a de-powdering step; 3. washing or solvent extraction after the de-powdering step; 4. chemical reaction after the de-powdering step; and 5. combinations thereof. A condition for reuse is that the powder is not significantly altered. The fugitive fluid may either be entirely removed or may be substantially removed, such that only small amounts of re-processing of the powder are necessary.

Alteration can be defined as altering the chemistry, flow properties, packing properties, morphology, or particle size distribution of the powder. It is desirable to recycle the powder from one build to the next, so there could be multiple exposures of the powder to the fugitive fluid.

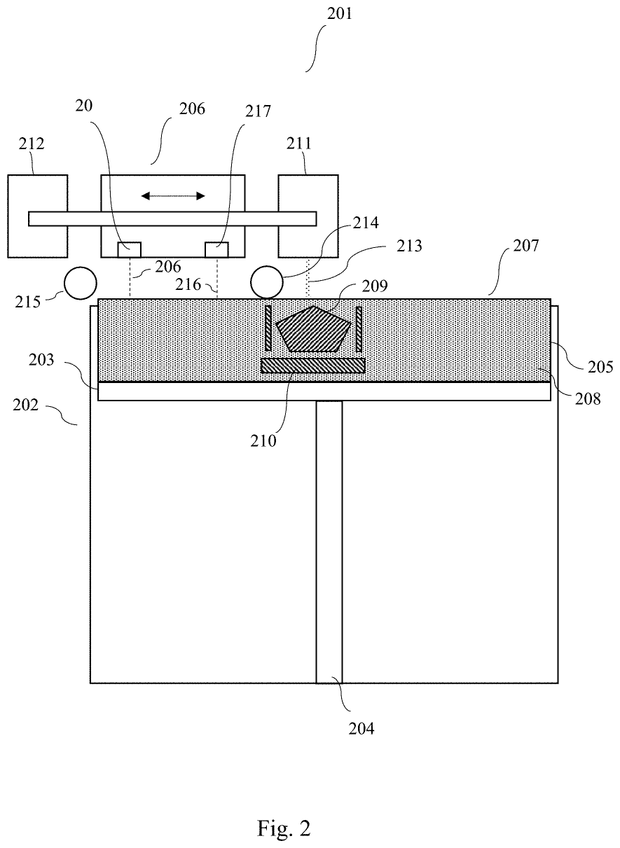

FIG. 2 depicts a side view cutaway of a binder jetting printing system 201 for practicing an embodiment method. There is a build box 202 in which parts are manufactured. In the embodiment, a build plate 203 is traversed downward via shaft 204 as successive layers are constructed. A bidirectional carriage 206 traverses a work surface 207 which may be the top of successive layers of the build box containing unbound powder 208, parts 209 and fugitive fluid regions 210. A first hopper 211 and second hopper 212 are configured to alternatively deposit powder 213 depending on the travel direction. The powder is spread into even layers of unbound powder by rollers 214 and 215. Fugitive fluid 216 is deposited by a first depositing apparatus 217 and binder 214 is deposited by a second depositing apparatus 215, which may be jetting heads. In the embodiment as viewed in FIG. 2, as the bidirectional carriage 206 traverses the working surface from left to right, the fugitive fluid binder 212 will be deposited prior to the binder 214 in the layer. Then, when traversing right to left, the binder will be deposited first. In many embodiments, this reversal of order in depositing the binder and fugitive fluid does not affect the positive benefits achieved by the use of the fugitive fluid because a primary benefit is the affect of the fugitive fluid on the formation of the subsequent layer. In other instances, if bi-directional printing is desired, a third and fourth depositing apparatuses in reverse order may be used to allow either the binder or fugitive fluid to be always deposited first. Alternatively, if jetting is only desired in one direction additional apparatuses would not be required. In certain alternative embodiments, the fugitive fluid is uniformly applied, for example by a precoating of the binder, vapor condensation, spray, or similar type of application.

The choice of the specific printing method and the specific hardware will dictate some requirements around the fugitive fluid's properties. Different printing technologies require different viscosities, surface tensions, and other characteristics for the process to function properly. The complementary volumes may or may not depend on the shape of parts.

There are complementary volumes which depend on the shape of the part they complement. These include, for example, where the fugitive fluid is printed as a negative of the image of nested parts, where fugitive fluid is printed as a regular or random pattern in the negative image of nested parts, and where the fugitive fluid is printed as the same image as nested parts. These complementary volumes may require a high resolution method (˜150 dpi or better) such as inkjet jetting.

There are also complementary volumes which do not depend on the shape of the parts they complement. These include, for example, uniform lattices, checkerboards and randomly dithered printing throughout bed. The fugitive binder may be applied uniformly to the entire layer, for example by vapor or spray deposition after powder spreading. This may be acceptable in embodiments when the fugitive fluid and binder interact in a way that allows printing of binder into the fugitive fluid or the fugitive fluid to be added on top of binder. These complementary volumes may permit use of a lower resolution (<150 dpi) method as explained further below.

An alternative fugitive fluid approach can be based on compatibility of the binder and fugitive binder such that either the binder can be applied in regions that contain fugitive binder or vice visa-versa (or both).

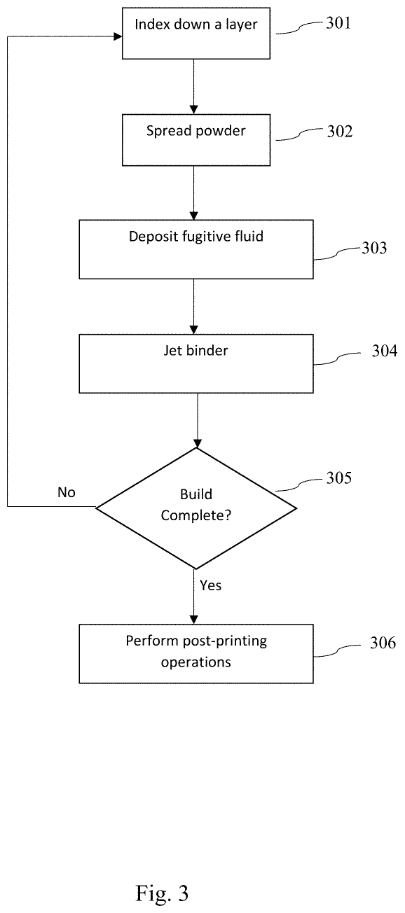

FIG. 3 is a flow chart of an embodiment method. In step 301, a working surface is indexed down relative to a carriage. In step 302 powder is spread across the working surface. In step 303, fugitive fluid is deposited in a predetermined pattern. In step 304, binder is jetted in a predetermined pattern. The order of steps 303 and 304 may be reversed, or they may be completed simultaneously as a single step. If the build is not complete at step 305, the next layer is begun. Once the build is complete, in step 306 post-printing operations can be performed. It should be noted that based on the designed parts and their requirements, in some layers there may be no fluid deposited at all, and in other layers, one or both fluids may be deposited.

In order to facilitate fugitive fluid removal through evaporation during a drying step, it may be desirable to ensure that the region of the powder bed in which the fugitive fluid is printed retains an “open” porosity. That is, there should be an interconnected network of pores connected with the surface of the shape, to allow the diffusion or convection of the fugitive fluid in the vapor phase to percolate to the surface of the powder bed. This may allow for a more rapid evaporation/removal of the fugitive fluid during drying. Such open porosity may be created by ensuring that the saturation remains below a specified value, where saturation is defined as the ratio of the volume of fugitive fluid to the volume of pore space between powder particles; or in the case where both binder fluid and fugitive fluid are deposited into the same region of the powder bed, the ratio of the volume of binder fluid plus fugitive fluid to the volume of pore space between powder particles. In some examples, the saturation may be maintained in the range of 40%-100%, or more preferably may be in the range of 50-80%. It should also be recognized that saturation values outside of these ranges may also be used to achieve the desired effect. Some examples of patterns that would allow for open porosity include a lattice or grid structure, a connected network of pores with a size (such as between 50 and 500 μm in diameter) sufficient to ensure open area for vapor migration, a honeycomb pattern, or any other pattern or printing strategy which would produce a similar effect.

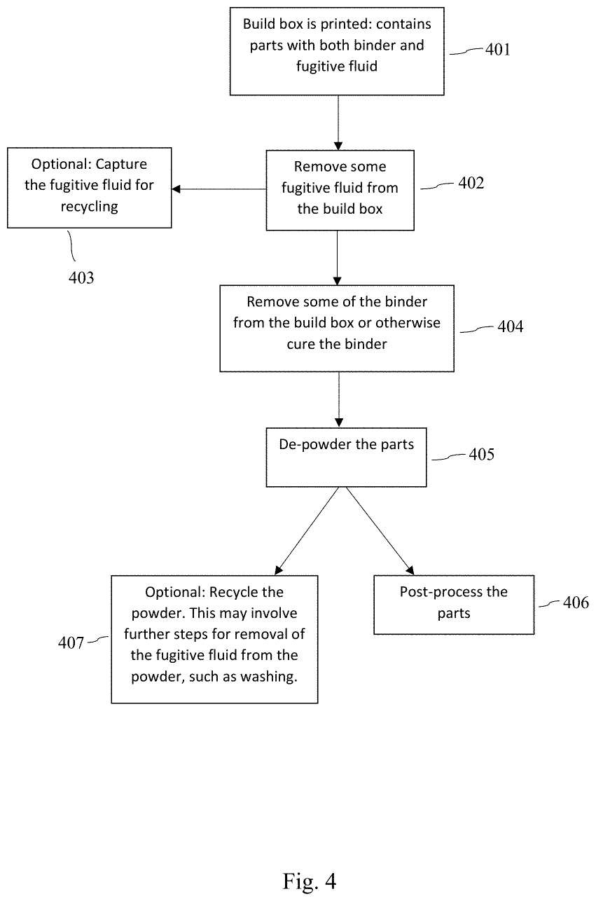

FIG. 4 depicts a flowchart for a method of removing the fugitive fluid. In step 401, the build box has been printed and contains both the binder bound parts and powder with fugitive fluid applied to it. In step 402 fugitive fluid is removed from the build box, for example by an evaporation or other process. In some instances, fugitive fluid may be recyclable and can be captured for further use in step 403. In step 404 a portion of the binder may be removed from the build box. The parts are then de-powdered in step 405. The parts having been separated from loose powder it may be further processed for example by sintering in a sintering furnace to remove remaining binder and densify the parts.

The order of removal of the fugitive fluid and partial removal of the binder (e.g. drying/crosslinking) may be different (e.g. inverted) than shown. Similarly, all the fugitive fluid may be removed after the de-powdering process. In many embodiments, the removal of the fugitive fluid and the drying of the binder may happen simultaneously during the drying and curing. Optionally, the unbound powder may then be recycled in step 407 after any remaining fugitive fluid is removed, if required.

The fugitive fluid and removal method may be chosen such that the removal of the fugitive fluid does not interfere with the function of the binder. For example, low volatility components of a fugitive fluid may require additional steps (such as washing or heating after de-powdering) since removing them via heating may require temperatures higher than the onset of thermal decomposition of the binder. Similarly, a fugitive fluid or some components thereof may be removed in multiple steps. These steps may occur after de-powdering, provided that the components of the fugitive fluid that remain during the de powdering step do not interfere with de-powdering of parts.

A build box may be printed using a combination of the binder fluid and fugitive fluid. After printing of the build box, the objective is to remove the parts from the build box so that that they may be used and/or post-processed via a de-powdering process. As such, the majority of binders in binder jet printing require some type of drying and/or curing process - this makes the parts handleable and strong. For sinterable powders, specifically, the powder-fluid mixtures tend to be very viscous due to the small particle size, and generally any fugitive fluid needs to be dried prior to de-powdering such that the de-powdering process does not need to remove a highly viscous suspension (i.e. sludge) from around the fragile green parts. Therefore, in this process flow, there is also a step for removing the fugitive fluid from the build box, for instance by a thermally-assisted drying process. In certain embodiments, the build box may be heated while optionally passing a gas through/around the powder bed to carry away the evaporated fluid. The fugitive fluid may be removed from the build box before, during, or after the binder is dried and/or cured. The order of events for the removal steps will depend on the properties of the two fluids, and how various components of each fluid are evaporated from the build box. The two fluids may be evaporated concurrently, and they may be very chemically similar to one another such that their evaporation characteristics are well-matched.

The removal of the fugitive fluid may follow certain rules to assure that it is compatible with the binder fluid. Primarily, the fugitive fluid should be able to be removed in a manner that does not damage or otherwise degrade the function of the binder and powder being used in the printing process. The primary concern here is for thermally-assisted drying. For example, if components of the fugitive fluid have boiling points substantially above the temperature at which a polymer in the binder fluid starts to degrade, then those components would not be compatible with an atmospheric-pressure drying process. In general, the components of the fugitive fluid should be selected based on being evaporated at relatively low temperatures, where a low temperature is defined according to the powder and the binder being used. A good heuristic is that many polymers will begin to degrade if they are held around 200° C. or higher for extended time periods, so boiling points below around 200° C. are preferred. For example, water and isopropanol may be good candidates for use in an fugitive fluid, whereas a higher boiling-point constituent, such as glycerol (boiling point of 290° C.), would need to be used in very small amounts, or would need to be removed through a processing involving vacuum or washing of the exposed powder after printing.

Where salts or other inorganic substances are to be used (e.g., for pH adjustment or buffering), it is useful for these to be volatile with an increase in temperature, such that they do not cause contamination after a drying process. For example, when a basic solution is desired, adding ammonia or related compounds is preferred relative to many of the strong bases (e.g. potassium or sodium hydroxide: KOH, NaOH) because the sodium and potassium are undesirable contaminants in most metals. Similar concerns apply to acidic buffering (e.g., use of acetic acid vs hydrochloric acid).

In the situation where all of the constituents are not able to be removed from the print bed because some of the components of the fugitive fluid have low vapor pressures up to the degradation temperature of a component of the binder fluid, achieving good de-powdering results may also be achieved by manipulation of printing process parameters and the printed geometries. For example, the mechanical properties of wet granular materials (i.e., a print bed containing a fluid) are not a strong function of the fluid content across a wide range of saturation of the pore space (for example between 30-70% saturation). As a result, the saturation of the printed region may be manipulated to achieve better de-powdering results of the area containing the fugitive fluid. Similarly, printing of an easily broken and/or friable structure in the space outside of the parts would result in easier de powdering.

As mentioned above, one does not necessarily need to remove all components of the fugitive fluid in the drying step where the powder and parts are all contained within a build box. Rather, one could use a second process to remove the rest of the fugitive fluid so long as the build is easily de-powdered after the first drying step. For example, one could use a high molecular weight polymer at low weight percentages to increase the viscosity of the fugitive fluid, and wash this polymer off of the powder from the de powdering process with a liquid wash. The solvent chosen for the washing should be capable of dissolving the residual compounds of interest. For a water-based fluid, this could be a wash in a deionized water bath, and subsequent drying prior to printing again. In another example, a second thermal step can be used to remove residual fugitive fluid components from the powder, after the depowdering step. Because the second thermal step is not conducted in the presence of parts bound with binder, the second step could utilize different process parameters to more aggressively remove the fugitive binder, for example, higher temperature to evaporate a higher boiling point component, lower pressures (i.e., vacuum), or different environments (e.g. addition of oxygen to burn off residual components).

The fugitive fluid may be used to prevent unwanted spread of binder fluid. To this end, the fugitive fluid may be printed next to the parts and therefore retain the binder fluid in the regions where it is intended to be by chemical immiscibility. There may be regimes of fugitive fluid saturations where this effect is stronger (i.e., the fugitive fluid must be printed above a certain saturation to provide this edging effect). This may result in reduced bleeding (i.e., lateral or vertical spreading of binder fluid beyond where it is printed) and reduced smearing. This may require low solubility of the fugitive fluid in the binder fluid.

The fugitive fluid may be selected to have a different chemistry than the binder fluid or may be selected to have a similar chemistry to the binder fluid.

One advantage of choosing a fugitive fluid that has different chemistry than the binder fluid (e.g. water based vs. non-polar) is that the fugitive fluid may also act as an edging fluid and retain the binder where it is desired to be. Non-polar substances are generally more expensive than water and may often be too expensive to be used as fugitive fluids unless they are recovered and recycled.

An advantage of choosing a fugitive fluid with similar volatility to the binder system (i.e., using a water-based binder with a water-based fugitive fluid) is that they may require similar drying cycles, and so the drying cycle may be short and does not need to be customized to accommodate the fugitive fluid and the binder fluid's different evaporation behaviors. In the case where the fugitive fluid is a solvent for the components which cause binding in the binder fluid, if the fugitive fluid and the binder fluid are brought into contact, the binder molecules may diffuse into the region where the fugitive fluid was deposited, causing poor edge definition and bleeding to be exacerbated. The behavior of powder and fluids can be complex. In some cases, a powder may be conditioned with the proper amount of a material to enhance imbibition of the binder into the powder. For example, steaming may substantially improve the imbibition of binder into the powder, yet over steaming may cause the binder to bleed, producing poor edge definition. Thus, the exact amount and method of application of the fugitive binder may depend on both the binder and the powder and even the method of powder handling. Thus, the use of a fugitive binder that is a similar chemistry to the binder may demand more accurate application than that which uses a different chemistry.

Examples of fugitive fluids and removal methods for an aqueous binder system:

| Fugitive Fluid | Removal Method | Mutual Solubility |
|---|---|---|
| Isobutyl Alcohol | Concurrent evaporation | Low/Med - |
| | during binder drying | 8.7 mL/100 mL |
| Water - isopropyl | Concurrent evaporation | Miscible |
| alcohol with | during binder drying + | |
| polymeric viscosity | washing | |
| modifiers (see | | |
| supplementary | | |
| material 12) | | |
| Water - Glycerol | Concurrent evaporation | Miscible |
| mixture | during binder drying + | |
| | washing | |
| Silicone oil | Washing of powder | Very Low |
| Xylene + viscosity | Concurrent evaporation + | Very Low |
| modifiers (see | washing | |
| supplementary | | |
| material 13) | | |

Isobutyl alcohol is one example of a fugitive fluid with for use with an aqueous binder. Isobutyl alcohol is advantageous because it has a viscosity (3.95 cP at 20° C.) that makes it good for printing with certain applicators such as the SAMBA G3L® printhead by Fujifilm Corporation of Valhalla, N.Y., without need for further viscosity-increasing additives. Further, isobutyl alcohol is volatile (107.8 C boiling point) enough to be removed from demonstrated print beds during a binder drying process without the need for a separate washing process.

Water-isopropyl alcohol with a viscosity modifier. Isopropyl alcohol may be used to adjust surface tension without a large influence in viscosity. The viscosity modifier may be used to tune the viscosity so that it is jettable in the printing process. The viscosity modifier may be glycerol that is removed through vacuum distillation or washing with water after, or a water-soluble polymer added in low concentrations such as poly(vinyl alcohol), poly(acrylic acid), or poly(ethylene glycol) that is removed through washing the powder with water. Concentrations of the polymer at less than 1 wt.% and appropriate concentrations of glycerol may leave the regions where the fluid is printed sufficiently un-bound that depowdering may be achieved easily.

Xylene as the main solvent with higher-order hydrocarbons (e.g., octanol, decanol, etc.) viscosity modifiers. The amount and molecular weight of the hydrocarbons may be flexibly selected to tune the boiling point and viscosity fairly independently. The cyclohexanone may be mixed with other solvents (e.g., methyl ethyl ketone, cyclohexane, etc.) to alter the boiling point profile.

Described now are various build box configurations of binder and fugitive fluid. FIG. 5 depicts a formation wherein a raft 501 of fugitive fluid is deposited in layers below a part 502 of binder bound powder. Unbound powder (white) 503 surrounds the part and the raft, and a layer of unbound powder is left to remain between the raft 501 and the part 502.

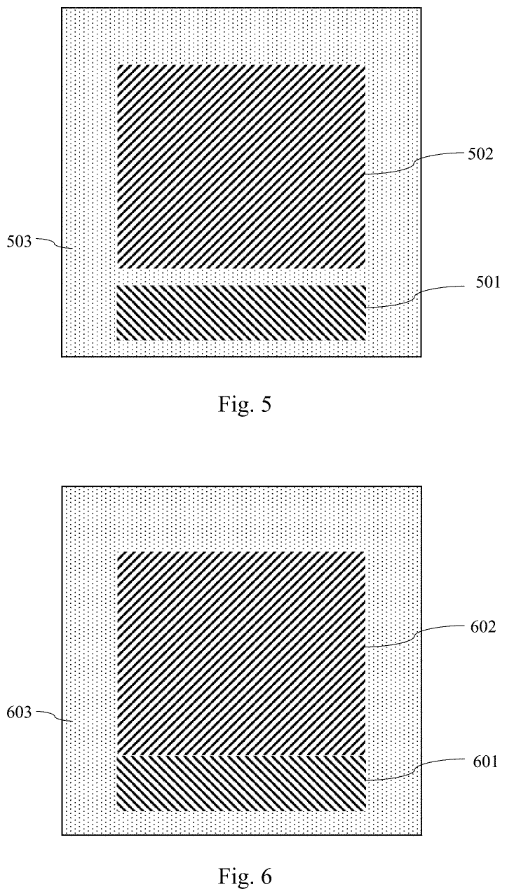

FIG. 6 depicts a similar build box configuration to FIG. 5 but the raft 601 is not separated from the part 602 by unbound powder 603 but rather directly abuts it.

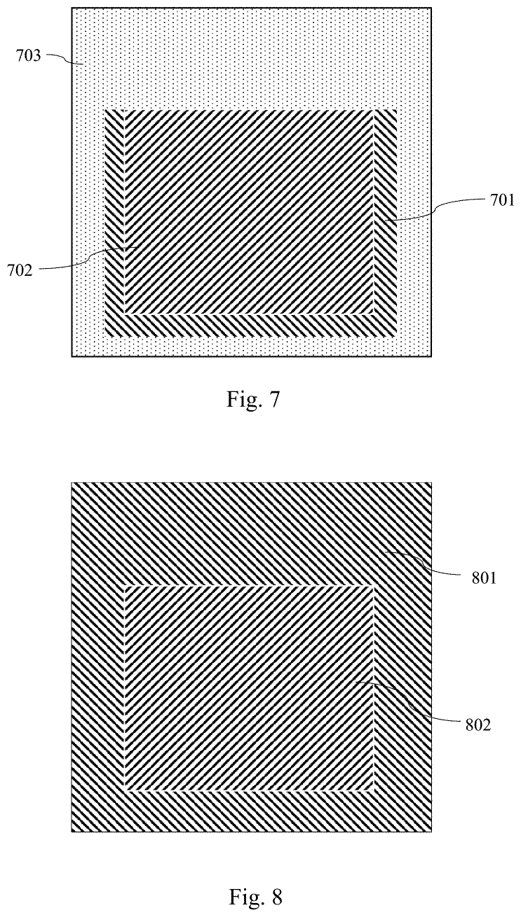

FIG. 7 depicts a complementary shape 701 of fugitive fluid surrounding a portion of an outside geometry of a part 702 and separating that portion of the part 702 from unbound powder 703.

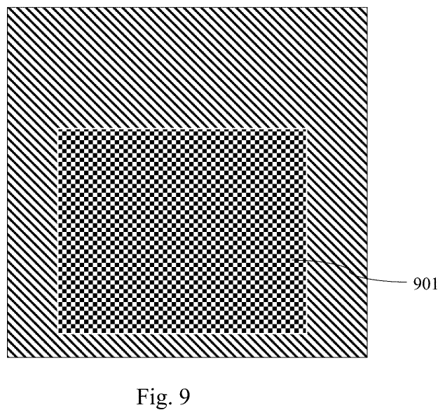

FIG. 8 depicts an embodiment build box in which fugitive fluid is deposited in a region 801 including anywhere in the build box where binder is not jetted for part 802.

FIG. 9 is a schematic side view of a powder bed in which a fugitive fluid is applied to all the powder in a powder bed including that which is bound into the part 901.

What is claimed is:

1. A retort configuration having reduced contamination, comprising:
a retort disposed within a furnace and configured to receive a inflow of process gas through a inlet; and
at least one getter configured to lessen the number of reactive species within the retort during a thermal processing cycle.

2. The retort configuration of claim 1 wherein the getter is disposed within the retort during the thermal processing cycle.

3. The retort configuration of claim 1 wherein the getter is disposed exterior to the retort during the thermal processing cycle.

4. The retort configuration of claim 3 wherein the getter is disposed on a top of the retort.

5. The retort configuration of claim 1 wherein the retort includes a bottom plate, a plurality of stacked retort components and a top plate.

6. The retort configuration of claim 4 wherein the top plate includes a recess for receiving the at least one getter.

7. The retort configuration of claim 1 wherein the retort is configured for horizontal flow of the process gas.

8. The retort configuration of claim 1 wherein the retort is configured for vertical flow of the process gas.

9. The retort configuration of claim 1 wherein the at least one getter is zirconium or a zirconium alloy.

10. The retort configuration of claim 9 wherein the at least one getter is a pulverized sponge or sponge grit.

11. A method of reducing contamination of parts during a thermal processing cycle, comprising:
disposing a retort containing a part to be processed and at least one getter within a furnace; and
providing a flow of process gas through the retort while conducting a thermal processing cycle, wherein the getter reacts with reactive agents in the furnace.

12. The method of claim 11 wherein the getter is disposed within the retort.

13. The method of claim 11 wherein the getter is disposed exterior to the retort.

14. The method of claim 11 wherein the getter is disposed on a top of the retort.

15. The method of claim 11 wherein the retort includes a bottom plate, a plurality of stacked retort components and a top plate.

16. The method of claim 15 wherein the top plate includes a recess for receiving the at least one getter.

17. The method of claim 11 wherein the process gas flow flows horizontally through the retort.

18. The method of claim 11 wherein the process gas flow flows vertically through the retort.

19. The method of claim 11 wherein the at least one getter is zirconium or a zirconium alloy.

20. The method of claim 19 wherein the at least one getter is a pulverized sponge or sponge grit.
